(19) United States
(12) Patent Application Publication
(10) Pub. No.: US 2013/0046757 A1
(43) Pub. Date: Feb. 21, 2013

(54) INDICATING RELATIONSHIP CLOSENESS BETWEEN SUBSNIPPETS OF A SEARCH RESULT

(71) Applicants: Franco Salvetti, San Francisco, CA (US); David Ahn, San Francisco, WA (US); Andrea Burbank, Chicago, IL (US)

(72) Inventors: Franco Salvetti, San Francisco, CA (US); David Ahn, San Francisco, WA (US); Andrea Burbank, Chicago, IL (US)

(73) Assignee: Microsoft Corporation, Redmond, WA (US)

(21) Appl. No.: 13/211,341

(22) Filed: Aug. 17, 2011

(51) Int. Cl. G06F 17/30

(52) U.S. Cl. 707/723; 707/E17.014

(57) ABSTRACT

Architecture that generates and presents a separator interface element in association with subsnippets (of search results) to indicate to the user the closeness relationship between subsnippets. The closeness can be presented in terms of bytes, words, paragraphs, semantic distance, rhetorical relationship, and so on, which assist the user in determining how closely related the parts of the document are in which the search terms appear. The element can be a box, for example, that is sized in length proportional to an inter-subsnippet closeness relationship.

### BACKGROUND

When a user enters a query into a search engine, the search results returned typically comprise a linked title, a URL (uniform resource locator), and a short textual description. This description, referred to as a snippet, typically includes one or more subsnippets, each of which contains one or more matches in the result document to a term in the query, together with some surrounding context. These subsnippets are typically separated by ellipses.

A search user typically intends the terms in the query to be associated with each other in some way in the most relevant documents. When query term matches are presented in different subsnippets, it is difficult to tell how those subsnippets are related.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture generates and provides an indicator (or other separator interface element) in association with subsnippets (of search results) to inform the user of the closeness relationship between subsnippets. The closeness can be presented in terms of bytes, words, paragraphs, semantic distance, rhetorical relationship, and so on, which assist the user in determining how closely related the parts of the document are in which the search terms appear. Techniques can be utilized to determine relationships between subsnippets extracted from a document such as a web document.

While subsnippets extracted from a web document as part of the search result snippet are typically separated by standard ellipses, the architecture employs the separator interface element to readily indicate the closeness relationship (e.g., distance) between the subsnippets in the web document. The element can be a box, for example, that is sized in length proportional to an inter-subsnippet closeness relationship. In another example, the element can be a series of dots the number of which increases or decreases in proportion to the closeness relationship.

The closeness relationship can be based on a single metric or multiple metrics. For example, beyond basic surface-form-based distance metrics (e.g., distance in bytes, words, sentences, DOM (document object model)-tree elements), the closeness relationship (e.g., distance) can be computed between subsnippets (and optionally associated pre-segmented contexts) in lexico-semantic space using any standard metric for lexico-semantic distance. Both the semantic and surface-form distance metrics can be combined into a single distance metric.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates the document and the subsnippets for the search result of FIG. 1.

FIG. 3 illustrates a method in accordance with the disclosed architecture.

FIG. 4 illustrates further aspects of the method of FIG. 3.

FIG. 5 illustrates a block diagram of a computing system that executes subsnippet closeness relationship in accordance with the disclosed architecture.

### DETAILED DESCRIPTION

The disclosed architecture generates and provides indicators between subsnippets of textual information in search results to inform the user of a closeness relationship between the subsnippets. For example, the closeness relationship of two subsnippets can be distant from each other as presented in the document. Accordingly, this is distance is then indicated to the viewer in the corresponding search result on a results page.

The closeness can be presented in terms of bytes, words, paragraphs, semantic distance, rhetorical relationship, and so on, which assist the user in determining how closely related the parts of the document are in which the search terms appear. Techniques can be utilized to determine relationships between subsnippets extracted from a document such as a web document.

While subsnippets extracted from a web document as part of the search result snippet are typically separated by standard ellipses, the architecture employs the separator interface element to readily indicate the closeness relationship (e.g., distance) between the subsnippets in the web document. The element can be a box, for example, that is sized in length proportional to an inter-subsnippet closeness relationship. In another example, the element can be a series of dots the number of which increases or decreases in proportion to the closeness relationship.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

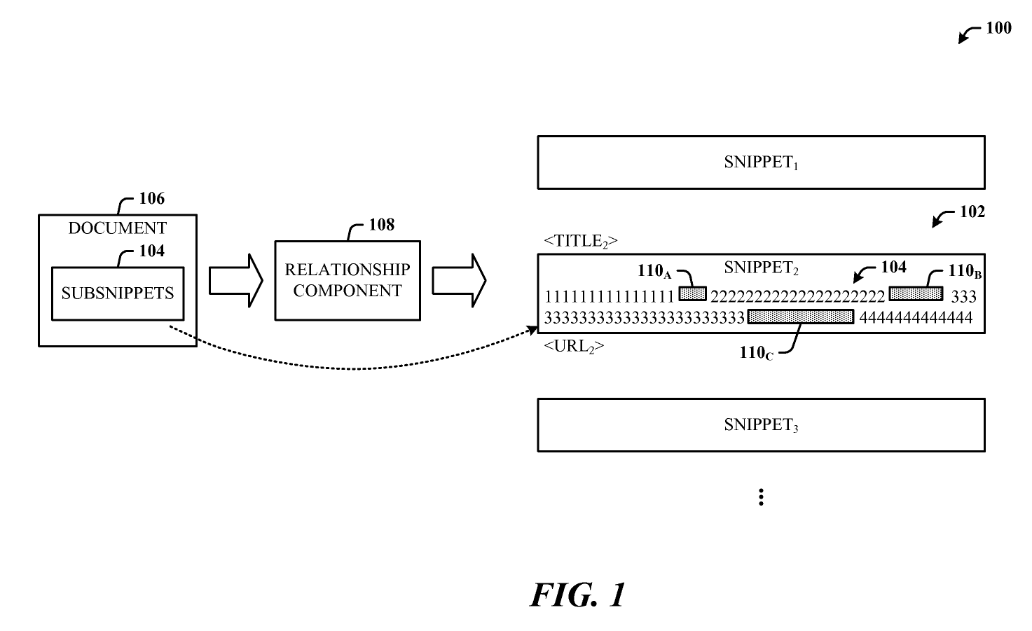

FIG. 1 illustrates a system 100 in accordance with the disclosed architecture. The system 100 includes a search result 102 presented as having subsnippets 104 (denoted as four subsnippets 111 . . . , 2222 . . . , 333 . . . , and 444 . . . ) of information from a document 106, and a relationship component 108 that inserts elements 110 in the search result 102 relative to the subsnippets 104 which indicate a closeness relationship between the subsnippets 104 as located in the document 106.

The elements 110 are presented with features (different dimensional sizes, colors, etc.) proportional to a surface distance, for example, computed between the subsnippets 104 in the document 106. The feature of an element can be related to size of the element. The closeness relationship can be computed based on a semantics distance. The elements 110 are inserted between the subsnippets. The closeness relationship can be based on distance of a subsnippet relative to one or more topics in the document 106. The closeness relationship can be computed based on a combination of semantic distance and surface distance between subsnippets 104 in the document 106.

In this example implementation, the elements 110 are small rectangle graphically presented objects sized in length proportional to the closeness relationship of the subsnippets 104 in the document 106. A first element 110_{A} is of a first length (e.g., a short distance) which indicates the closeness relationship between the first subsnippet 111 . . . and the second subsnippet 222 . . . . A second element 110_{B} is of a second length (e.g., a medium distance) which indicates the closeness relationship between the second subsnippet 222 . . . and the third subsnippet 333 . . . and a third element 110_{C} is of a third length (e.g., long distance) which indicates the closeness relationship between the third subsnippet 333 . . . and the fourth subsnippet 444 . . . . It is to be understood that additional lengths can be employed as desired.

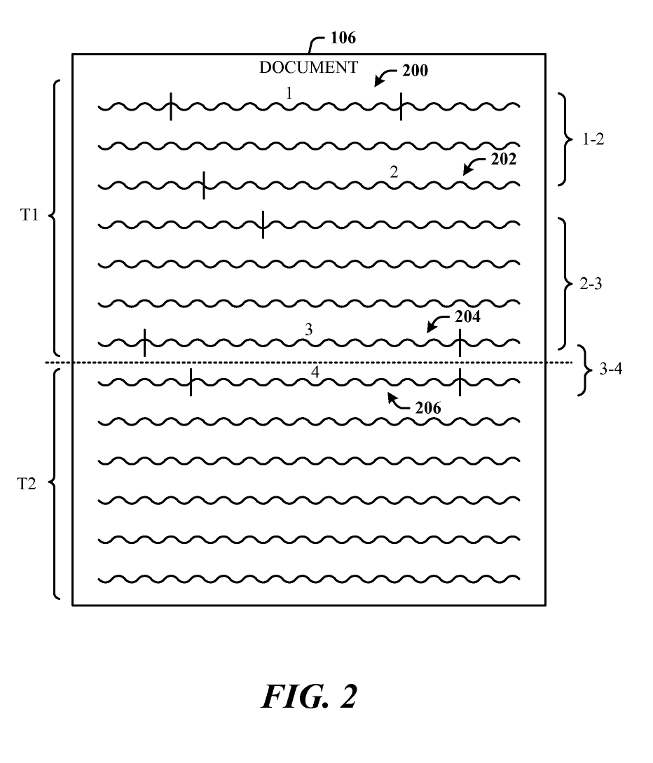

FIG. 2 illustrates the document 106 and the subsnippets 104 for the search result 102 of FIG. 1. The document 106 is the full document that includes two topics: T1 and T2. Topic T1 includes the first subsnippet 200, the second subsnippet 202, and the third subsnippet 204. Topic T2 includes the fourth subsnippet 206.

In terms of pure surface distance, the surface distance between the first subsnippet 200 and second subsnippet 202 (also denoted as 1-2) is determined according to some metric to be a short distance, and accordingly, the element 110_{A} depicted between the subsnippets in the search result 102 of FIG. 1 is a short length object. Similarly, the surface distance between the second subsnippet 202 and third subsnippet 204 (also denoted 2-3) is determined according to some metric to be a medium distance, and accordingly, the element 110_{B} depicted between the subsnippets in the search result 102 of FIG. 1 is a medium length object. The surface distance between the third subsnippet 204 and fourth subsnippet 206 (also denoted 3-4) is determined according to some metric to be a high distance, and accordingly, the element 110_{C} depicted between the subsnippets in the search result 102 of FIG. 1 is a long length object. The distance is high because the distance is determined across the topics T1 and T2 (the separation represented by the dotted line). In other words, that the lexico-semantic distance between 204 and 206 is high due to the cross-topic difference, even though the surface distance is low. Using lexico-semantic distance based on discourse structure gives the user more useful information than using purely surface distances. The gradations can also include a very high distance element, as desired.

The subsnippets can be limited to textual information, or other media types such as images, links, and so on.

Put another way, a system is provided that comprises subsnippets of textual information obtained from a web document (the document 106) and employed in a search result, and the relationship component 108 that inserts visual elements (the elements 110) in association with the subsnippets which indicate a closeness relationship between the subsnippets as located in the web document.

The closeness relationship between subsnippets is indicated by a visual element sized proportional to a surface distance computed between the subsnippets in the web document. The closeness relationship between two subsnippets is indicated by an element sized proportional to a semantic distance computed between the two subsnippets in the web document. The closeness relationship between two subsnippets is represented by a correspondingly sized visual element (e.g., short for short distance, long for high distance, etc.) inserted between the two subsnippets. The closeness relationship between two subsnippets is based on topics in the web document in which the subsnippets are located. The closeness relationship between two subsnippets is computed based on a combination of semantic distance and surface distance between the two subsnippets in the web document.

Another technique for determining the closeness relationship is discourse parsing. Other techniques can be employed as well, separately, or in various combinations with the other techniques.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

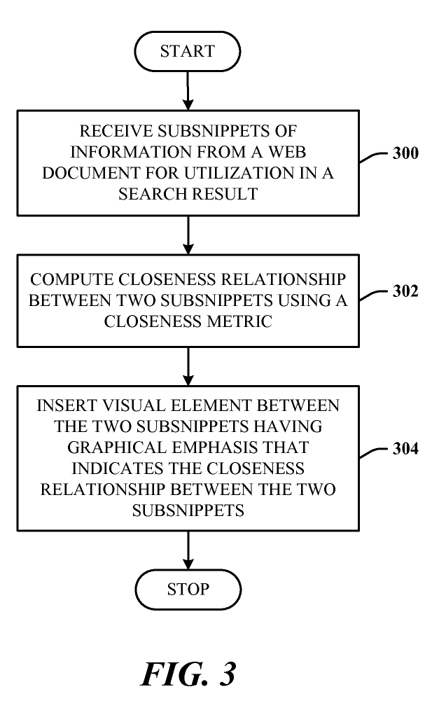

FIG. 3 illustrates a method in accordance with the disclosed architecture. At 300, subsnippets of information are received from a web document for utilization in a search result. At 302, a closeness relationship between two subsnippets is computed using a closeness metric. At 304, a visual element is inserted between the two subsnippets having graphical emphasis that indicates the closeness relationship between the two subsnippets.

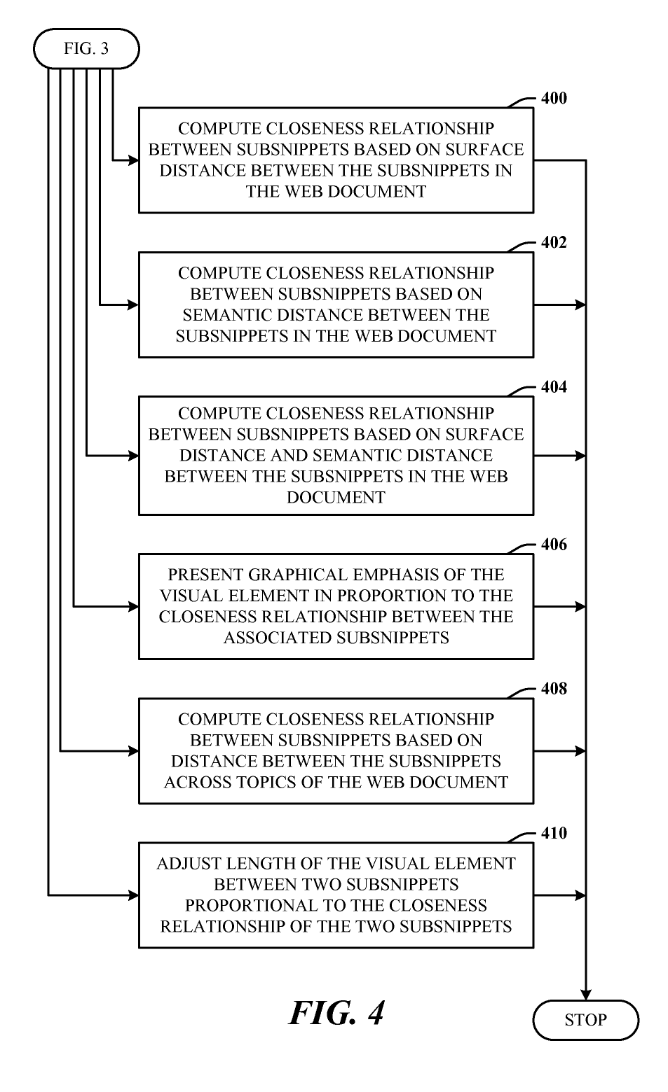

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, the closeness relationship between subsnippets is computed based on surface distance between the subsnippets in the web document. At 402, the closeness relationship between subsnippets is computed based on semantic distance between the subsnippets in the web document. At 404, the closeness relationship between subsnippets is computed based on surface distance and semantic distance between the subsnippets in the web document. At 406, the graphical emphasis (e.g., length, color, object fill, etc.) of the visual element is presented in proportion to the closeness relationship between the associated subsnippets. At 408, the closeness relationship between subsnippets is computed based on distance between the subsnippets across topics of the web document. At 410, the length of the visual element between two subsnippets is adjusted proportional to the closeness relationship of the two subsnippets.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

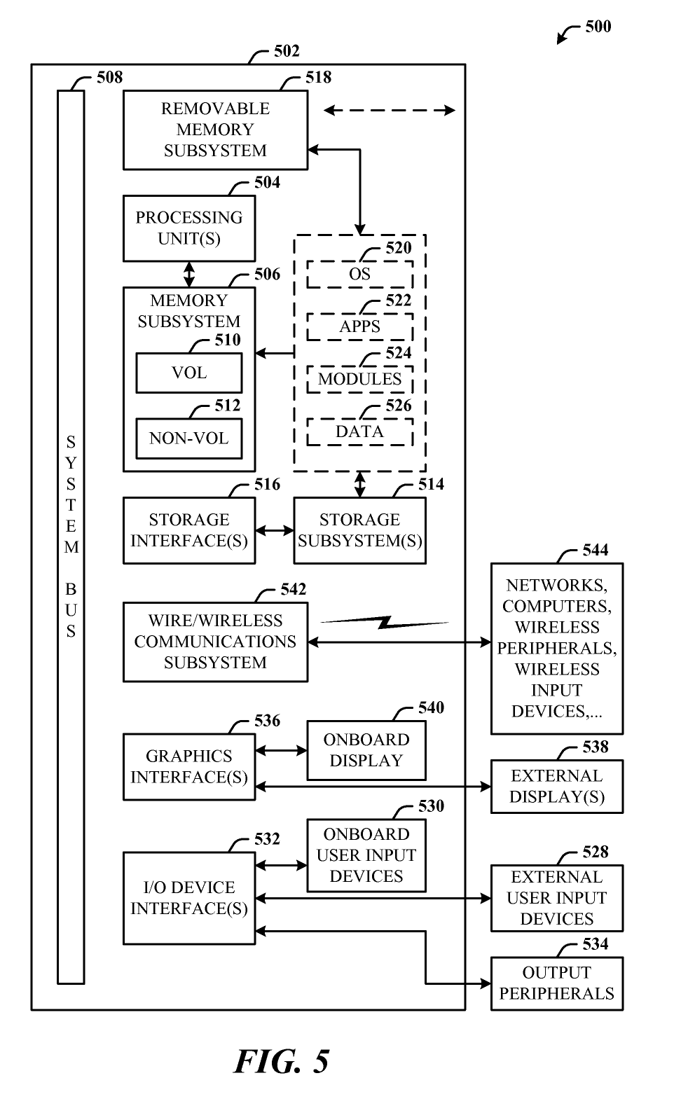

Referring now to FIG. 5, there is illustrated a block diagram of a computing system 500 that executes subsnippet closeness relationship in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The operating system 520, one or more application programs 522, other program modules 524, and/or program data 526 can include the entities and components of the system 100 of FIG. 1, the document 106 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a search result presented as having subsnippets of information from a document;
a relationship component that inserts elements in the search result relative to the subsnippets which indicate a closeness relationship between the subsnippets as located in the document; and
a processor that executes computer-executable instructions associated with the relationship component.

2. The system of claim 1, wherein the elements are presented with features proportional to a surface distance computed between the subsnippets in the document.

3. The system of claim 2, wherein the feature of an element is related to size of the element.

4. The system of claim 1, wherein the closeness relationship is computed based on semantics distance.

5. The system of claim 1, wherein the elements are inserted between the subsnippets.

6. The system of claim 1, wherein the closeness relationship is based on distance of a subsnippet relative to one or more topics in the document.

7. The system of claim 1, wherein the closeness relationship is computed based on a combination of semantic distance and surface distance between subsnippets in the document.

8. A computer-implemented system, comprising:
subsnippets of textual information obtained from a web document and employed in a search result;
a relationship component that inserts visual elements in association with the subsnippets which indicate a closeness relationship between the subsnippets as located in the web document; and
a processor that executes computer-executable instructions associated with the subsnippets and the relationship component.

9. The system of claim 8, wherein the closeness relationship between subsnippets is indicated by a visual element sized proportional to a surface distance computed between the subsnippets in the web document.

10. The system of claim 8, wherein the closeness relationship between two subsnippets is indicated by an element sized proportional to a semantic distance computed between the two subsnippets in the web document.

11. The system of claim 8, wherein the closeness relationship between two subsnippets is represented by a correspondingly sized visual element inserted between the two subsnippets.

12. The system of claim 8, wherein the closeness relationship between two subsnippets is based on topics in the web document in which the subsnippets are located.

13. The system of claim 8, wherein the closeness relationship between two subsnippets is computed based on a combination of semantic distance and surface distance between the two subsnippets in the web document.

14. A computer-implemented method, comprising acts of:
receiving subsnippets of information from a web document for utilization in a search result;
computing a closeness relationship between two subsnippets using a closeness metric;
inserting a visual element between the two subsnippets having graphical emphasis that indicates the closeness relationship between the two subsnippets; and
utilizing a processor that executes instructions stored in memory to perform at least one of the acts of computing or inserting.

15. The method of claim 14, further comprising computing the closeness relationship between subsnippets based on surface distance between the subsnippets in the web document.

16. The method of claim 14, further comprising computing the closeness relationship between subsnippets based on semantic distance between the subsnippets in the web document.

17. The method of claim 14, further comprising computing the closeness relationship between subsnippets based on surface distance and semantic distance between the subsnippets in the web document.

18. The method of claim 14, further comprising presenting the graphical emphasis of the visual element in proportion to the closeness relationship between the associated subsnippets.

19. The method of claim 14, further comprising computing the closeness relationship between subsnippets based on distance between the subsnippets across topics of the web document.

20. The method of claim 14, further comprising adjusting length of the visual element between two subsnippets proportional to the closeness relationship of the two subsnippets.
